(19) United States
(12) Patent Application Publication
(10) Pub. No.: US 2025/0058410 A1
(43) Pub. Date: Feb. 20, 2025

(54) DIGITAL TWIN FOR LASER MATERIAL PROCESSING

(71) Applicant: Applied Materials, Inc., Santa Clara, CA (US)

(72) Inventors: Gagandeep Singh Joshi, Ontario (CA); Joseph Frederick Behnke, San Jose, CA (US); Joseph Frederick Sommers, Roseville, CA (US)

(21) Appl. No.: 18/234,723

(22) Filed: Aug. 16, 2023

(51) Int. Cl. B23K 26/0622

(52) U.S. Cl. CPC B23K 26/0622

(57) ABSTRACT

A method includes determining first data indicative of processing parameters for processing a material in a laser processing system comprising a digital twin. The method further includes providing the first data as input to a trained machine learning model, wherein the digital twin comprises the trained machine learning model. The method further includes obtaining one or more outputs of the trained machine learning model, the one or more outputs indicating predicted performance data associated with the processing parameters for processing the material. The method further includes causing, based on the predicted performance data, the material to be processed according to the processing parameters.

### TECHNICAL FIELD

The instant specification generally relates to laser material processing. More specifically, the instant specification relates to a digital twin for laser material processing.

### BACKGROUND

Laser material processing can utilize a laser material processing system to process materials. Laser material processing systems can be costly in terms of resources spent to prototype and build a system, time spent during use, and materials used. By using a digital twin for laser material processing, wasted resources, time, and materials can be mitigated.

### SUMMARY

The following is a simplified summary of the disclosure in order to provide a basic understanding of some aspects of the disclosure. This summary is not an extensive overview of the disclosure. It is not intended to delineate any scope of the particular implementations of the disclosure or any scope of the claims. Its sole purpose is to present some concepts of the disclosure in a simplified form as a prelude to the more detailed description that is presented later.

Technologies directed to an advanced method for laser material processing are described. In some embodiments, a method includes determining first data indicative of processing parameters for processing a material in a laser processing system including a digital twin. The method further includes providing the first data as input to a trained machine learning model, where the digital twin includes the trained machine learning model. The method further includes obtaining one or more outputs of the trained machine learning model, the one or more outputs indicating predicted performance data associated with the processing parameters for processing the material. The method further includes causing, based on the predicted performance data, the material to be processed according to the processing parameters.

In some embodiments, a system includes a memory and a processing device coupled to the memory. The processing device is to determine first data indicative of processing parameters for processing a material in a laser processing system comprising a digital twin. The processing device is further to provide the first data as input to a trained machine learning model, wherein the digital twin comprises the trained machine learning model. The processing device is further to obtain one or more outputs of the trained machine learning model, the one or more outputs indicating predicted performance data associated with the processing parameters for processing the material. The processing device is further to cause, based on the predicted performance data, the material to be processed according to the processing parameters.

In some embodiments, a non-transitory machine-readable storage medium includes instructions that, when executed by a processing device, cause the processing device to determine first data indicative of processing parameters for processing a material in a laser processing system comprising a digital twin. The processing device is further to provide the first data as input to a trained machine learning model, wherein the digital twin comprises the trained machine learning model. The processing device is further to obtain one or more outputs of the trained machine learning model, the one or more outputs indicating predicted performance data associated with the processing parameters for processing the material. The processing device is further to cause, based on the predicted performance data, the material to be processed according to the processing parameters.

### BRIEF DESCRIPTION OF THE DRAWINGS

Aspects and implementations of the present disclosure will be understood more fully from the detailed description given below and from the accompanying drawings, which are intended to illustrate aspects and implementations by way of example and not limitation.

FIG. 1 is a block diagram illustrating an example system architecture, according to certain embodiments.

FIG. 2 illustrates a data set generator to create data sets for a machine learning model associated with obtaining predicted performance data associated with processing parameters for processing a material and causing, based on the predicted performance data, the material to be processed according to the processing parameters, according to certain embodiments.

FIG. 3 is a block diagram illustrating determining predictive data associated obtaining predicted performance data associated with processing parameters for processing a material and causing, based on the predicted performance data, the material to be processed according to the processing parameters, according to certain embodiments.

FIG. 4 is an example of predicted profiles of a material processed by a laser material processing system, according to some embodiments.

FIGS. 5A-B are flow diagrams of methods associated with obtaining predicted performance data associated with processing parameters for processing a material and causing, based on the predicted performance data, the material to be processed according to the processing parameters, according to certain embodiments.

FIG. 6 is a block diagram illustrating a computer system, according to certain embodiments.

### DETAILED DESCRIPTION

Embodiments of the present disclosure are directed to systems and methods for laser material processing using a digital twin (e.g., utilization of digital twin technology to enhance advanced manufacturing for laser material processing tools and control strategies). Laser material processing utilizes lasers to manipulate and modify various types of materials (e.g., for etching operations, drilling operations, etc.). To achieve precise and desired results, a laser material processing system incorporates many tunable settings and parameters. These settings and parameters may include laser pulse frequency, gas pressure, beam intensity, focal length, scanning speed, beam diameter, material composition, and many others. The specific combination and adjustment of these settings can play a crucial role in determining the outcome of the laser material processing.

For example, one particular challenge in laser material processing is the drilling of uniform holes in substrates. This task can be intricate due to several factors. For instance, issues such as punch-through, where the hole tapers or widens towards the exit, can occur. Additionally, necking, which refers to the narrowing of the hole near its opening, may also be encountered. These examples highlight some of the complexities and potential issues associated with processing substrates using a laser material processing system.

Conventionally, a process space (e.g., a range of parameters, conditions, and outcomes involved in laser processing a specific semiconductor substrate) was manually mapped out (e.g., by adjusting parameters and processing a material over many iterations to record the outcomes). However, this manual mapping approach is costly in terms of time spent and materials used, resource-intensive in terms of tools and manpower, and limited in its ability to cover large process spaces.

Aspects and implementations of the instant disclosure address the above-described and other shortcomings of conventional systems by using a digital twin to optimize the settings and parameters of a laser material processing system. The digital twin may encompass the critical components, settings, and parameters of the actual system, enabling real-time simulation and optimization of the laser material processing. In some embodiments, the digital twin includes a machine learning model trained to predict performance data associated with the processed material. The predicted performance data may include a predicted profile for material processing. Predicted profiles for laser material processing may include, for example, predicted profiles for laser cutting, laser welding, laser drilling, laser engraving, laser cladding, laser annealing, laser ablation, laser micromachining, laser scribing, laser marking, laser heat treatment, laser cleaning, laser peening, laser surface texturing, laser surface alloying, laser shock peening, and/or the like. In some embodiments, a predicted profile may be generated for any material processing including those not using a laser processing.

In some embodiments, to process a material in the laser processing system including the digital twin, processing parameters of the material are determined (e.g., based on user input identifying the processing parameters). The processing parameters may include, for example, material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, or focus position. The processing parameters may be provided as input to the trained machine learning model in the digital twin, and one or more outputs of the trained machine learning model may be obtained, where the one or more outputs indicate the predicted performance data associated with the processing parameters for the material. The predicted performance data can then be used to process the material according to the processing parameters.

In some embodiments, preferred processing parameters can be determined based on the predicted performance data meeting a performance criterion, which may be a uniformity criterion.

In some embodiments, the machine learning model is trained using training input data comprising historical processing parameters data and training target output data comprising historical performance data associated with the historical processing parameters.

Aspects and implementations of the present disclosure result in technological advantages. In particular, aspects of the present disclosure eliminate the need for manual mapping of process spaces, saving valuable time and reducing the consumption of materials and manpower. Additionally, aspects of the present disclosure allow for the optimization of each setting and parameter of the laser material processing system, enabling enhanced precision and efficiency.

Although some embodiments of the present disclosure describe laser material processing of semiconductor substrates in a semiconductor processing system, the present disclosure can be used for laser material processing of any material and/or substrate in any kind of processing system or for any kind of manufacturing.

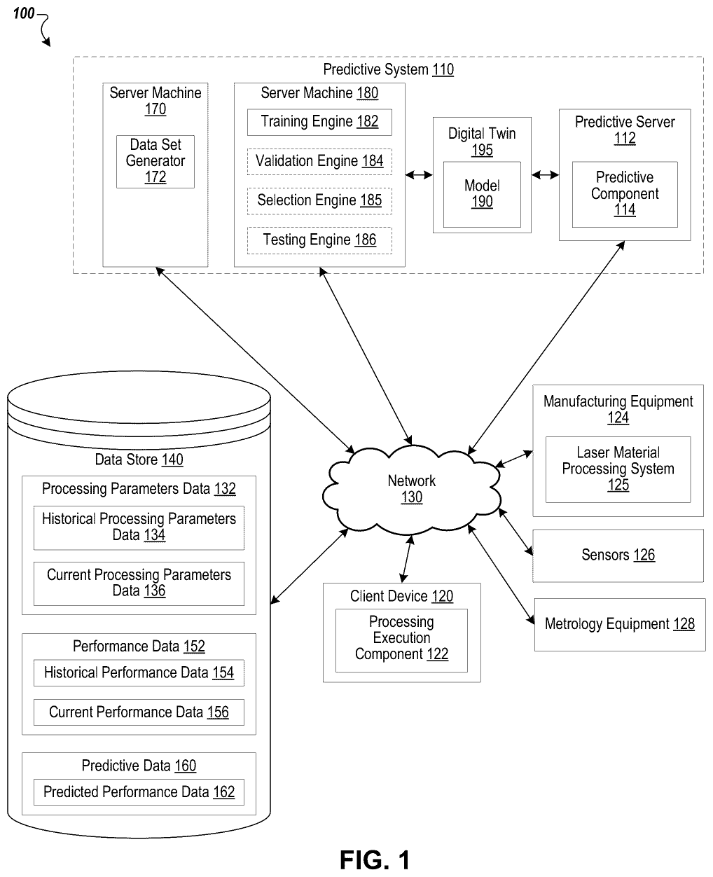

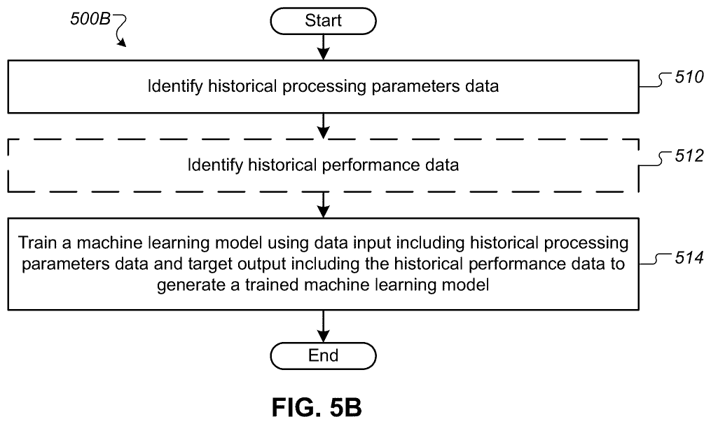

FIG. 1 is a block diagram illustrating an exemplary system 100 (exemplary system architecture), according to certain embodiments. The system 100 (e.g., processing execution component 122 and/or predictive component 114) can perform the methods described herein (e.g., methods 500A-C of FIGS. 5A-C). The system 100 includes a client device 120, manufacturing equipment 124, sensors 126, metrology equipment 128, a predictive server 112, and a data store 140. In some embodiments, the predictive server 112 is part of a predictive system 110. In some embodiments, the predictive system 110 further includes server machines 170 and 180.

In some embodiments, one or more of the client device 120, manufacturing equipment 124, sensors 126, metrology equipment 128, predictive server 112, data store 140, server machine 170, and/or server machine 180 are coupled to each other via a network 130 for generating predictive data 160 to perform laser material processing operations. In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. In some embodiments, network 130 includes one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the client device 120 includes a computing device such as Personal Computers (PCs), laptops, mobile phones, smart phones, tablet computers, netbook computers, etc. In some embodiments, the client device 120 includes a processing execution component 122. In some embodiments, the processing execution component 122 may also be included in the predictive system 110 (e.g., machine learning processing system). In some embodiments, the processing execution component 122 is alternatively included in the predictive system 110 (e.g., instead of being included in client device 120). Client device 120 includes an operating system that allows users to one or more of: consolidate, generate, view, or edit data; provide data to the predictive system 110 (e.g., machine learning processing system); etc.

In some embodiments, processing execution component 122 receives one or more of user input (e.g., via a Graphical User Interface (GUI) displayed via the client device 120), processing parameters data 132, property data (e.g., of a processed substrate/material), performance data 152, etc. In some embodiments, processing parameters data 132 includes processing parameters which may be, for example, material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, or focus position. In some embodiments, processing parameters include processing parameter values (e.g., a laser wavelength value, a gas pressure value, etc.) and processing settings. In some embodiment, processing parameters may be tunable settings in a processing operation (e.g., a laser material operation). In some embodiments, processing parameters may be variable properties of a processing operation, such as material type. In some embodiments, the processing execution component 122 transmits data (e.g., user input, processing parameters data 132, property data (e.g., of a processed substrate/material), performance data 152, etc.) to the predictive system 110, receives predictive data 160 from the predictive system 110, determines processing parameters based on the predictive data 160, and causes processing parameters to be implemented. In some embodiments, the predictive data 160 is associated with processing parameters (e.g., preferred processing parameters). In some embodiments, the predictive data 160 is associated with the outcome of a processing operation with processing parameters (e.g., preferred processing parameters). In some embodiments, processing performed according to processing parameters is associated with one or more of material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, or focus position, Computational Process Control (CPC), Statistical Process Control (SPC) (e.g., SPC to compare to a graph of 3-sigma, etc.), Advanced Process Control (APC), model-based process control, design optimization, updating of manufacturing parameters, wafer recipe modification, feedback control, machine learning modification, and/or the like.

In some embodiments, the processing execution component 122 stores data (e.g., user input, processing parameters data 132, property data (e.g., of a processed substrate/material), performance data 152, etc.) in the data store 140 and the predictive server 112 retrieves the data from the data store 140. In some embodiments, the predictive server 112 stores output (e.g., predictive data 160) of the trained machine learning model 190 in the data store 140 and the client device 120 retrieves the output from the data store 140. In some embodiments, the processing execution component 122 receives an indication of processing parameters (e.g., based on processing parameters associated with predictive data 160) from the predictive system 110 and causes performance of a processing operation (e.g., a laser material processing operation) using the processing parameters (e.g., execution of processing according to processing parameters).

In some embodiments, the predictive server 112, server machine 170, and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 112 includes a predictive component 114. In some embodiments, the predictive component 114 identifies (e.g., receives from the client device 120, retrieves from the data store 140, etc.) processing parameters data 132 (e.g., processing parameters) and generates predictive data 160 associated with execution of processing according to the processing parameters data (e.g., laser material processing operations, etc.). In some embodiments, the predictive component 114 uses digital twin 195 to determine the predictive data 160. In some embodiments, digital twin 195 includes one or more trained machine learning models 190 to determine the predictive data 160. In some embodiments, trained machine learning model 190 is trained using historical processing parameters data 134 and historical performance data 154.

In some embodiments, predictive system 110 uses a digital twin (e.g., a digital representation) of a laser material processing system to determine the outcome of execution of a laser material processing operation with certain processing parameters. The digital twin of a laser material processing system can employ principles and/or equations specific to laser-material interactions, optical physics, and thermal dynamics to model the behavior of the system during the execution of laser material processing operations. The digital twin may utilize fundamental principles such as laser-material absorption, reflection, and scattering to simulate the interaction between the laser beam and the target material. Equations related to the laser's energy distribution, beam profile, and intensity modulation may be incorporated to accurately represent the behavior of the laser within the digital twin.

In addition, the digital twin may incorporate equations and models that govern thermal effects within the material being processed. Heat transfer equations, such as the heat conduction equation, may be utilized to simulate the propagation and dissipation of thermal energy within the material. This helps in predicting temperature gradients, heat-affected zones, and thermal effects such as melting, recrystallization, or phase transformations. The integration of these principles and equations within the digital twin of a laser material processing system enables a representation of the physical phenomena occurring during the laser material processing.

To reliably predict and/or estimate the outcome of a laser material processing operation with certain parameters, a machine learning model can be included as part of or be otherwise used by the digital twin. The machine learning model 190 may be a physics-informed machine learning model that is informed by the digital twin. The digital twin 195 can determine performance data associated with the execution of a laser material processing operation with certain parameters based on the output of the model. For example, for a given type of material (e.g., aluminum), the digital twin 195 can determine a predicted profile, which can be a representation or description of the predicted outcome or characteristics of a processed material after a laser material processing operation. For example, a predicted profile may include parameters such as the shape, dimensions, surface quality, and other relevant features of the processed material as predicted by model 190. A predicted profile enables assessment and optimization of the processing parameters of a laser material processing operation, ensuring desired results and meeting specific requirements. In some embodiments, a predicted profile may be a three-dimensional rendering of a predicted outcome of a material and/or substrate processed by a processing system (e.g., laser material processing system).

As previously discussed, a digital replica may include a physics-based model of one or more physical assets of the laser material processing system. Processing parameters data 132 may encapsulate relationships, parameters, specifications, etc. associated with one or more aspects of the physics-based model. For example, within a laser material processing system, the physics-based model can provide insights into the relationship between the laser beam characteristics (such as power, wavelength, and spot size) and the resulting material processing outcomes. The model can indicate how variations in these parameters influence aspects such as material ablation, melting, or modification. Furthermore, the physics-based model can establish connections between the optical properties of the material being processed (such as absorption coefficient, reflectivity, and thermal conductivity) and the heat transfer dynamics during laser-material interaction. This helps in predicting and optimizing factors such as temperature distribution, heat-affected zone, and thermal stress within the processed material. The processing parameters can be associated with modifications to system components, such as the laser beam delivery optics, focusing lenses, or beam shaping devices. These adjustments aim to optimize the laser-material interaction and achieve desired processing outcomes, such as precise material removal, surface texturing, hole drilling, etc.

As discussed herein, model 190 may operate in association with a digital twin (e.g., digital twin 195). As used herein, a digital twin is a digital replica of a physical asset, such as a manufactured part or a processing chamber. The digital twin can include characteristics of the physical asset at each stage of laser material processing, in which the characteristics include, but are not limited to, material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, or focus position, among other things.

In some embodiments, digital twin 195 and/or model 190 may employ statistical modeling to predict laser material processing outcomes corresponding to processing parameter data 132. The predicted or estimated outcomes (e.g., predicted performance data 162, predictive data 160, etc.) may include a predicted profile of the processed material. In some embodiments, a predicted profile may include parameters such as the shape, dimensions, surface quality, and other relevant features of the processed material as predicted by digital twin 195 and/or model 190. A statistical model may be used to process predicted performance data 162 based on previously processed historical performance data 154 using statistical operations to validate, predict, and/or transform the predicted performance data 162. In some embodiments, the statistical model is generated using statistical process control (SPC) analysis to determine control limits for data and identify data as being more or less dependable based on those control limits. In some embodiments, the statistical model is associated with univariate and/or multivariate data analysis. For example, various parameters can be analyzed using the statistical model to determine patterns and correlations through statistical processes (e.g., range, minimum, maximum, quartiles, variance, standard deviation, and so on). In another example, relationships between multiple variables can be ascertained using regression analysis, path analysis, factor analysis, multivariate statistical process control (MCSPC) and/or multivariate analysis of variance (MANOVA).

In some embodiments, the predictive system 110 (e.g., predictive server 112, predictive component 114) generates predictive data 160 using supervised machine learning (e.g., supervised data set, historical processing parameters data 134 labeled with historical performance data 154, etc.). In some embodiments, predictive data 160 may include predicted performance data 162. In some embodiments, the predictive system 110 generates predictive data 160 (including predicted performance data 162) using semi-supervised learning (e.g., semi-supervised data set, performance data 152 is a predictive percentage, etc.). In some embodiments, the predictive system 110 generates predictive data 160 (including predicted performance data 162) using unsupervised machine learning (e.g., unsupervised data set, clustering, clustering based on historical processing parameters data 134, etc.).

In some embodiments, the manufacturing equipment 124 includes one or more of a processing chamber, deposition chamber, cluster tool, wafer backgrind systems, wafer saw equipment, die attach machines, wirebonders, die overcoat systems, molding equipment, hermetic sealing equipment, metal can welders, deflash/trim/form/singulation (DTFS) machines, branding equipment, lead finish equipment, and/or the like. In some embodiments, the manufacturing equipment 124 includes a laser material processing system 125. In some embodiments, the manufacturing equipment 124 is part of a substrate processing system (e.g., integrated processing system). The manufacturing equipment 124 includes one or more of a controller, an enclosure system (e.g., substrate carrier, front opening unified pod (FOUP), autoteach FOUP, process kit enclosure system, substrate enclosure system, cassette, etc.), a side storage pod (SSP), an aligner device (e.g., aligner chamber), a factory interface (e.g., equipment front end module (EFEM)), a load lock, a transfer chamber, one or more processing chambers, a robot arm (e.g., disposed in the transfer chamber, disposed in the front interface, etc.), and/or the like. The enclosure system, SSP, and load lock mount to the factory interface and a robot arm disposed in the factory interface is to transfer content (e.g., substrates, process kit rings, carriers, validation wafer, etc.) between the enclosure system, SSP, load lock, and factory interface. The aligner device is disposed in the factory interface to align the content. The load lock and the processing chambers mount to the transfer chamber and a robot arm disposed in the transfer chamber is to transfer content (e.g., substrates, process kit rings, carriers, validation wafer, etc.) between the load lock, the processing chambers, and the transfer chamber. In some embodiments, the manufacturing equipment 124 includes components of substrate processing systems. In some embodiments, the performance data 152 of a laser material processing system 125 results from the laser material processing system 125 performing one or more laser material processing operations (e.g., laser drilling, laser etching, laser annealing, laser ablation, laser doping, laser scribing, laser welding, laser deposition, laser trim and repair, etc.).

In some embodiments, the laser material processing using laser material processing system 125 involves converting a laser beam from a source into a circularly polarized light by utilizing a quarter-wave plate to prevent anisotropic absorption on an ablating surface. A beam may then be directed towards an aperture galvo-scan head, which includes an F-Theta lens, after passing through a suitable beam expander. The beam may be focused onto a material surface, creating a specific beam spot size. To ensure optimal results, meticulous manual optimization is required throughout this entire process, including adjusting parameters such as wavelength, pulse energy, average power, repetition rate, hatch distance, marking speed, milling strategy, optical bench set up and beam alignment, etc. Implementing digital twin technology allows for realization of optimization objectives for laser machining processes, such as enhancing product quality, increasing production output, reducing energy consumption, minimizing material waste, and improving process stability. To attain these objectives in real time and optimize the economic model of the laser material processing tool, advanced process control using a digital twin can be beneficial.

In some embodiments, the sensors 126 provide performance data 152 (e.g., sensor values, such as historical sensor values and current sensor values) of the laser material processing system (e.g., laser drilling performance data, laser etching performance data, laser annealing performance data, laser ablation performance data, laser doping performance data, laser scribing performance data, laser welding performance data, laser deposition performance data, laser trim and repair performance data, etc.).

In some embodiments, the sensors 126 and/or metrology equipment 128 include one or more of a metrology tool such as optical microscopes (used to determine the properties and surfaces of laser processed materials by measuring material characteristics such as hole depth, hole uniformity, etc.), ellipsometers (used to determine the properties and surfaces of thin films by measuring material characteristics such as layer thickness, optical constants, surface roughness, composition, optical anisotropy, etc.), ion mills (used to prepare heterogeneous bulk materials when wide areas of material are to be uniformly thin), capacitance-voltage (C-V) systems (used to measure the capacitance versus voltage and capacitance versus time (C-t) characteristics of substrates, such as semiconductor devices), interferometers (used to measure distances in terms of wavelength, and to determine wavelengths of particular light sources), source measure units (SME) magnetometers, optical and imaging systems, profilometers, wafer probers (used to test a semiconductor wafer before it is separated into individual dies or chips), imaging stations, critical-dimension scanning electron microscope (CD-SEM, used to ensure the stability of the manufacturing process by measuring critical dimensions of substrates), reflectometers (used to measure the reflectivity and radiance from a surface), resistance probes (used to measure the resistivity of thin-films), resistance high-energy electron diffraction (RHEED) system (used to measure or monitor crystal structure or crystal orientation of epitaxial thin-films of silicon or other materials), X-ray diffractometers (used to unambiguously determine crystal structure, crystal orientation, film thickness and residual stress in silicon wafers, epitaxial films, or other substrates), and/or the like.

In some embodiments, the performance data 152 is used for product health (e.g., product quality). In some embodiments, the performance data 152 is received over a period of time.

In some embodiments, sensors 126 and/or metrology equipment 128 provide performance data 152 including one or more of morphology data, size attribute data, dimensional attribute data, image data, optical micrographs, scanning electron microscope (SEM) images, energy-dispersive x-ray (EDX) images, spatial location data, elemental analysis data, wafer signature data, chip layer, chip layout data, edge data, grey level data, signal to noise data, temperature data, spacing data, electrical current data, power data, voltage data, and/or the like.

In some embodiments, performance data 152 includes morphology data (e.g., data that relates to the form of a substrate, such as laser etching depth, laser etching uniformity, surface topography, etc.). In some embodiments, performance data 152 includes size attribute data (e.g., data describing the size of attributes of a substrate). In some embodiments, performance data 152 includes dimensional attribute data (e.g., data that describes the dimensions of attributes of a substrate). In some embodiments, performance data 152 includes SEM images (e.g., images captured by a scanning electron microscope using a focused beam of electrons to scan a surface of a substrate to create a high-resolution image). In some embodiments, performance data 152 includes EDX images (e.g., images generated from data that is collected using an x-ray technique to identify the elemental composition of materials). In some embodiments, performance data 152 includes defect distribution data (e.g., data that describes the spatial distribution, temporal distribution, etc. of defects on a substrate). In some embodiments, performance data 152 includes spatial location data (e.g., data that describes the spatial location of attributes, defects, elements, etc. of a substrate). In some embodiments, performance data 152 includes elemental analysis data (e.g., data that describes the elemental composition of a substrate). In some embodiments, performance data 152 includes wafer signature data (e.g., data that describes distribution of wafer defects of a substrate originating from a single manufacturing problem). In some embodiments, performance data 152 includes chip layer data (e.g., associated with a layer or operation in the substrate manufacturing process). In some embodiments, performance data 152 includes chip layout data (e.g., data that describes the layout of a substrate is terms of planar geometric shapes). In some embodiments, performance data 152 includes edge data (e.g., data that describes the edge of a wafer). For example, edge data may describe chipped edges, wafer edge thickness, wafer bow, wafer warp, etc. In some embodiments, performance data 152 includes grey level data (e.g., data that describes the brightness of a pixel of an image of a substrate) and signal to noise data (e.g., data that describes the signal to noise ratio of a substrate measure with, for example, spectrometry equipment).

In some embodiments, the performance data 152 (e.g., historical performance data 154, current performance data 156, etc.) is processed by the client device 120 and/or by the predictive server 112. In some embodiments, processing of the performance data 152 includes generating features. In some embodiments, the features are a pattern in the performance data 152 (e.g., slope, width, height, peak, etc.) or a combination of values from the performance data 152 (e.g., power derived from voltage and current, etc.). In some embodiments, the performance data 152 includes features that are used by the predictive component 114 for obtaining predictive data 160.

In some embodiments, metrology equipment 128 can be included as part of the manufacturing equipment 124. For example, metrology equipment 128 can be included inside of or coupled to a processing chamber and configured to generate metrology data (e.g., performance data 152, current performance data 156, etc.) for a substrate and/or material, during and/or after undergoing a laser material process (e.g., laser drilling process, laser etching process, laser annealing process, laser ablation process, laser doping process, laser scribing process, laser welding process, laser deposition process, laser trim and repair process, etc.) while the substrate remains in a processing chamber. In some instances, metrology equipment 128 can be referred to as in-situ metrology equipment. In another example, metrology equipment 128 can be coupled to another station of manufacturing equipment 124. For example, metrology equipment can be coupled to a transfer chamber, a load lock, or a factory interface.

In some embodiments, the metrology equipment 128 (e.g., ellipsometry equipment, imaging equipment, spectroscopy equipment, etc.) is used to determine metrology data (e.g., inspection data, image data, spectroscopy data, ellipsometry data, material compositional, optical, or structural data, etc.) corresponding to substrates and/or materials produced by the manufacturing equipment 124 (e.g., laser material processing system 125, laser material processing equipment, etc.). In some examples, after the manufacturing equipment 124 processes substrates, the metrology equipment 128 is used to inspect the substrates. In some examples, after the manufacturing equipment 124 (e.g., laser material processing system 125) processes substrates, the sensors 126 are used to inspect the substrates and/or processed materials. In some embodiments, the metrology equipment 128 performs scanning acoustic microscopy (SAM), ultrasonic inspection, x-ray inspection, and/or computed tomography (CT) inspection. In some examples, after the manufacturing equipment 124 (e.g., laser material processing system 125) performs a laser material process on a substrate, the metrology equipment 128 is used to determine quality of the processed substrate (e.g., uniformity and quality of laser drilling, uniformity and quality of laser etching, laser annealing quality and uniformity, laser ablation quality and uniformity, laser doping uniformity and quality, laser scribing quality and uniformity, laser welding quality and uniformity, laser deposition quality and uniformity, laser trim and repair quality and uniformity, and/or the like). In some embodiments, the metrology equipment 128 includes an imaging device (e.g., SEM, optical microscope, SAM equipment, ultrasonic equipment, x-ray equipment, CT equipment, and/or the like). In some embodiments, performance data 152 includes sensor data from sensors 126 and/or metrology data from metrology equipment 128.

In some embodiments, performance data 152 includes sensor data from sensors 126 and/or metrology data from metrology equipment 128 located in-situ (e.g., inside a laser material processing chamber). In some embodiments, performance data 152 includes user input via client device 120 and/or metrology data from metrology equipment 128.

In some embodiments, performance data 152 data may be derived from metrology data and/or sensor data. Metrology data may be data describing metrology of a substrate. Sensor data may be data describing conditions and characteristics of a substrate or inside a processing chamber (e.g., a laser material processing chamber).

In some embodiments, the data store 140 is memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of processing parameters data 132, performance data 152, and/or predictive data 160.

In some embodiments, data store 140 can be configured to store data that is not accessible to a user of the manufacturing system. For example, process data, spectral data, contextual data, etc. obtained for a substrate being processed at the manufacturing system is not accessible to a user (e.g., an operator) of the manufacturing system. In some embodiments, all data stored at data store 140 can be inaccessible by the user of the manufacturing system. In some embodiments, a portion of data stored at data store 140 can be inaccessible by the user while another portion of data stored at data store 140 can be accessible by the user. In some embodiments, one or more portions of data stored at data store 140 can be encrypted using an encryption mechanism that is unknown to the user (e.g., data is encrypted using a private encryption key). In some embodiments, data store 140 can include multiple data stores where data that is inaccessible to the user is stored in one or more first data stores and data that is accessible to the user is stored in one or more second data stores.

Performance data 152 may include historical performance data 154 and current performance data 156. In some embodiments, at least a portion of the performance data 152 is from sensors 126 and/or metrology equipment 128. Performance data 152 may be indicative of whether a substrate is properly designed, is properly produced, has uniformity with the other substrates, and/or is properly functioning. Performance data 152 may be indicative of whether a substrate processing operation (e.g., laser material processing operation) is accurately carried out.

For example, performance data 152 for a laser drilling operation may be indicative of hole diameter, hole depth, hole quality (e.g., drilled holes should meet expected dimensions accurately and consistently and have little thermal damage or recast layers), etc. Performance data 152 for a laser etching operation may be indicative of feature accuracy (etched features should have precise dimensions, shapes, and edge quality), etch depth control (etching process should achieve the desired depth accurately and uniformly across the substrate), surface finish (etched surface should be smooth, free from roughness, and have the desired texture or pattern), etc. Performance data 152 for a laser annealing operation may be indicative of dopant activation (annealing process should effectively activate the dopants, achieving the desired electrical properties in the treated regions), crystal structure restoration (annealing process should eliminate amorphous regions or crystal defects), etc. Performance data 152 for a laser ablation operation may be indicative of material removal accuracy (laser ablation process should remove material precisely), surface quality (ablated surface should exhibit minimal heat-affected zones or recast layers), etc. Performance data 152 for a laser doping operation may be indicative of dopant incorporation (laser doping process should successfully introduce dopant atoms into the desired regions and achieved desired doping concentration), etc. Performance data 152 for a laser scribing operation may be indicative of line accuracy (laser scribing process should create precise and well-defined scribe lines with the desired width, depth, and edge quality), scribe width control (scribing process should accurately control the width of the scribe lines to avoid any electrical or structural issues), etc. Performance data 152 for a laser welding operation May be indicative of bond strength (laser welding should result in strong and reliable bonds between the joined components, meeting the specified mechanical and electrical requirements), heat-affected zone control (laser welding process should minimize the size and impact of the heat-affected zone to prevent damage to the surrounding materials or components), etc. Performance data 152 for a laser deposition operation may be indicative of layer thickness control (laser deposition should achieve the desired thickness and uniformity of deposited layers), adhesion, integrity (deposited layers should adhere well to the substrate and exhibit good integrity without cracks, delamination, or voids), etc. Performance data 152 for a laser trim and repair operation may be indicative of component modification accuracy (laser trim and repair processes should accurately modify circuitry or structures as required, achieving the desired modifications without causing unintended damage or changes), etc.

In some embodiments, at least a portion of the performance data 152 is associated with a quality of substrates produced by the manufacturing equipment 124 (e.g., laser material processing system 125). In some embodiments, at least a portion of the performance data 152 is based on metrology data from the metrology equipment 128 (e.g., historical performance data 154 includes metrology data indicating properly processed substrates, property data of substrates, yield, etc.). In some embodiments, at least a portion of the performance data 152 is based on inspection of the substrates (e.g., current performance data 156 based on actual inspection). In some embodiments, performance data 152 includes user input (e.g., via client device 120) indicating a quality of the substrates. In some embodiments, the performance data 152 includes an indication of an absolute value (e.g., inspection data of the substrates indicates missing threshold data by a calculated value, deformation value misses the threshold deformation value by a calculated value) or a relative value (e.g., inspection data of the substrates indicates missing the threshold data by 5%, deformation misses threshold deformation by 5%, hole uniformity misses threshold uniformity by 5%, etc.). In some embodiments, the performance data 152 is indicative of meeting a threshold amount of error (e.g., at least 5% error in laser etching uniformity following a laser material processing operation, at least 5% error in production, at least 5% error in flow, at least 5% error in deformation, specification limit, etc.).

In some embodiments, historical data includes one or more of historical processing parameters data 134 and/or historical performance data 154 (e.g., at least a portion for training the machine learning model 190). Current data includes one or more of current processing parameters data 136 and/or current performance data 156 (e.g., at least a portion to be input into the trained machine learning model 190 subsequent to training the model 190 using the historical data). In some embodiments, the current data is used for retraining the trained machine learning model 190.

In some embodiments, the predictive data 160 is to be used to predict the outcome of a laser processing operation based on processing parameter data (e.g., using certain processing parameters). Performing multiple laser material processing operations (e.g., each with different processing parameters) on multiple products to determine performance data using each set of processing parameters is costly in terms of time spent, materials used, etc. By providing processing parameters data 132 to model 190 and receiving predictive data 160 from the model 190, system 100 has the technical advantage of avoiding the costly process of performing multiple laser material processing operations (e.g., each with different processing parameters) on multiple products to determine performance data using each set of processing parameters and to avoid wasting time and discarding materials (e.g., substrates).

Performing manufacturing processes (e.g., laser material processing operations) with manufacturing equipment 124 and using certain processing parameters that result in defective products or damaged manufacturing equipment is costly in time, energy, products, manufacturing equipment 124, etc. By providing processing parameters data 132 to model 190, receiving predictive data 160 from the model 190, and obtaining predicted performance data 162 based on the predictive data 160, system 100 has the technical advantage of avoiding the cost of producing, identifying, and discarding defective substrates.

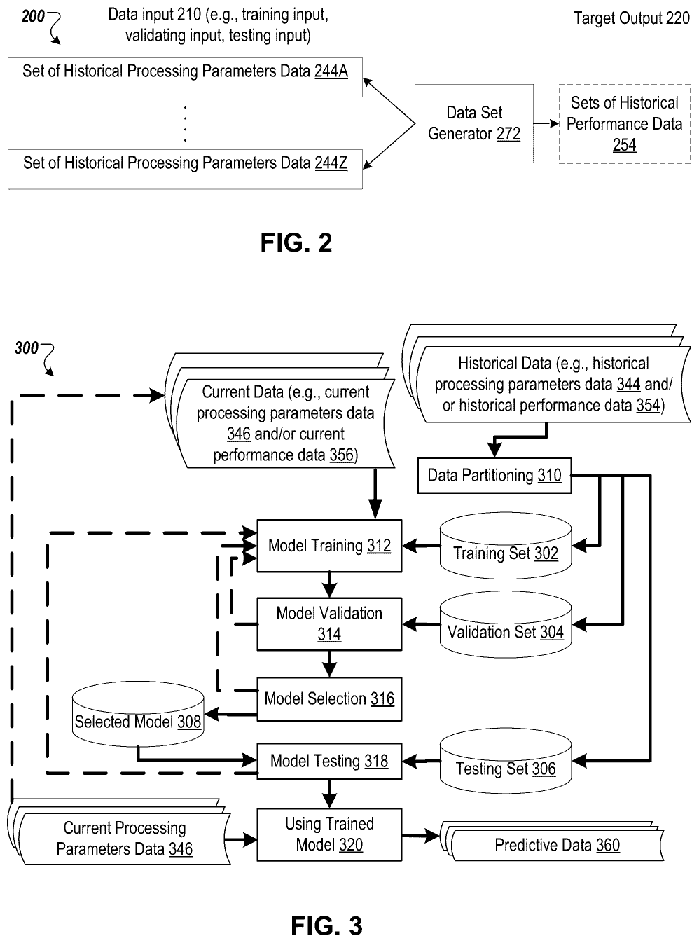

In some embodiments, predictive system 110 further includes server machine 170 and server machine 180. Server machine 170 includes a data set generator 172 that is capable of generating data sets (e.g., a set of data inputs and a set of target outputs) to train, validate, and/or test a machine learning model(s) 190. The data set generator 172 has functions of data gathering, compilation, reduction, and/or partitioning to put the data in a form for machine learning. In some embodiments (e.g., for small datasets), partitioning (e.g., explicit partitioning) for post-training validation is not used. Repeated cross-validation (e.g., 5-fold cross-validation, leave-one-out-cross-validation) may be used during training where a given dataset is in-effect repeatedly partitioned into different training and validation sets during training. A model (e.g., the best model, the model with the highest accuracy, etc.) is chosen from vectors of models over automatically-separated combinatoric subsets. In some embodiments, the data set generator 172 may explicitly partition the historical data (e.g., historical processing parameters data 134 and corresponding historical performance data 154) into a training set (e.g., sixty percent of the historical data), a validating set (e.g., twenty percent of the historical data), and a testing set (e.g., twenty percent of the historical data). Some operations of data set generator 172 are described in detail below with respect to FIG. 2 according to some embodiments. In some embodiments, the predictive system 110 (e.g., via predictive component 114) generates multiple sets of features (e.g., training features). In some examples a first set of features corresponds to a first set of types of property data (e.g., from a first set of sensors, first combination of values from first set of sensors, first patterns in the values from the first set of sensors) that correspond to each of the data sets (e.g., training set, validation set, and testing set) and a second set of features correspond to a second set of types of property data (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general-purpose computer system, or a dedicated machine), firmware, microcode, or a combination thereof. The training engine 182 is capable of training a machine learning model 190 using one or more sets of features associated with the training set from data set generator 172. In some embodiments, the training engine 182 generates multiple trained machine learning models 190, where each trained machine learning model 190 corresponds to a distinct set of parameters of the training set (e.g., processing parameters data 132) and corresponding responses (e.g., performance data 152). In some embodiments, multiple models are trained on the same parameters with distinct targets for the purpose of modeling multiple effects.

In some examples, a first trained machine learning model was trained using performance data 152 from all sensors 126 (e.g., sensors 1-5), a second trained machine learning model was trained using a first subset of the performance data (e.g., from sensors 1, 2, and 4), and a third trained machine learning model was trained using a second subset of the performance data (e.g., from sensors 1, 3, 4, and 5) that partially overlaps the first subset of features.

In some examples, a first trained machine learning model was trained using processing parameters data 132 from all sensors 126 (e.g., sensors 1-5), a second trained machine learning model was trained using a first subset of the processing parameters data (e.g., from sensors 1, 2, and 4), and a third trained machine learning model was trained using a second subset of the processing parameters data (e.g., from sensors 1, 3, 4, and 5) that partially overlaps the first subset of features.

The validation engine 184 is capable of validating a trained machine learning model 190 using a corresponding set of features of the validation set from data set generator 172. For example, a first trained machine learning model 190 that was trained using a first set of features of the training set is validated using the first set of features of the validation set. The validation engine 184 determines an accuracy of each of the trained machine learning models 190 based on the corresponding sets of features of the validation set. The validation engine 184 evaluates and flags (e.g., to be discarded) trained machine learning models 190 that have an accuracy that does not meet a threshold accuracy. In some embodiments, the selection engine 185 is capable of selecting one or more trained machine learning models 190 that have an accuracy that meets a threshold accuracy. In some embodiments, the selection engine 185 is capable of selecting the trained machine learning model 190 that has the highest accuracy of the trained machine learning models 190.

The testing engine 186 is capable of testing a trained machine learning model 190 using a corresponding set of features of a testing set from data set generator 172. For example, a first trained machine learning model 190 that was trained using a first set of features of the training set is tested using the first set of features of the testing set. The testing engine 186 determines a trained machine learning model 190 that has the highest accuracy of all of the trained machine learning models based on the testing sets.

In some embodiments, the machine learning model 190 (e.g., used for classification) refers to the model artifact that is created by the training engine 182 using a training set that includes data inputs and corresponding target outputs (e.g., correctly classifies a condition or ordinal level for respective training inputs). Patterns in the data sets can be found that map the data input to the target output (the correct classification or level), and the machine learning model 190 is provided mappings that captures these patterns. In some embodiments, the machine learning model 190 uses one or more of Gaussian Process Regression (GPR), Gaussian Process Classification (GPC), Bayesian Neural Networks, Neural Network Gaussian Processes, Deep Belief Network, Gaussian Mixture Model, or other Probabilistic Learning methods. Non probabilistic methods may also be used including one or more of Support Vector Machine (SVM), Radial Basis Function (RBF), clustering, Nearest Neighbor algorithm (k-NN), linear regression, random forest, neural network (e.g., artificial neural network), etc. In some embodiments, the machine learning model 190 is a multi-variate analysis (MVA) regression model.

Predictive component 114 provides current processing parameters data 136 (e.g., as input) to the trained machine learning model 190 and runs the trained machine learning model 190 (e.g., on the input to obtain one or more outputs). The predictive component 114 is capable of determining (e.g., extracting) predictive data 160 (e.g., including predicted performance data 162) from the trained machine learning model 190 and determines (e.g., extracts) uncertainty data that indicates a level of credibility that the predictive data 160 corresponds to current performance data 156. In some embodiments, the predictive component 114 or processing execution component 122 use the uncertainty data (e.g., uncertainty function or acquisition function derived from uncertainty function) to decide whether to use the predictive data 160 to perform a laser material processing operation according to processing parameters or whether to further train the model 190.

For purpose of illustration, rather than limitation, aspects of the disclosure describe the training of one or more machine learning models 190 using historical data (e.g., prior data, historical processing parameters data 134 and historical performance data 154) and providing current processing parameters data 136 into the one or more trained probabilistic machine learning models 190 to determine predictive data 160. In other implementations, a heuristic model or rule-based model is used to determine predictive data 160 (e.g., without using a trained machine learning model). In other implementations non-probabilistic machine learning models may be used. Predictive component 114 monitors historical processing parameters data 134 and historical performance data 154. In some embodiments, any of the information described with respect to data inputs 210 of FIG. 2 are monitored or otherwise used in the heuristic or rule-based model.

In some embodiments, the functions of client device 120, predictive server 112, server machine 170, and server machine 180 are to be provided by a fewer number of machines. For example, in some embodiments, server machines 170 and 180 are integrated into a single machine, while in some other embodiments, server machine 170, server machine 180, and predictive server 112 are integrated into a single machine. In some embodiments, client device 120 and predictive server 112 are integrated into a single machine.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 determines whether or not to perform a laser material processing operation according to processing parameters based on the predictive data 160. In another example, client device 120 determines the predictive data 160 based on data received from the trained machine learning model.

In addition, the functions of a particular component can be performed by different or multiple components operating together. In some embodiments, one or more of the predictive server 112, server machine 170, or server machine 180 are accessed as a service provided to other systems or devices through appropriate application programming interfaces (API).

A manufacturing system can perform one or more processes on a substrate (e.g., laser material processes). A substrate can be any suitably rigid, fixed-dimension, planar article, such as, e.g., a silicon-containing disc or wafer, a patterned wafer, a glass plate, or the like, suitable for fabricating electronic devices or circuit components thereon.

Laser material processing chambers can carry out any number of processes on substrate. A same or different substrate process can take place in each individual processing chamber. Laser material processing chambers can include one or more sensors configured to capture data for substrate before, after, or during a substrate process. For example, the one or more sensors can be configured to capture hole diameter, depth, uniformity, etc. of the substrate.

A processing chamber can perform each substrate manufacturing process (e.g., a laser material processing operation, etc.) according to a process recipe (e.g., according to processing parameters). A process recipe defines a particular set of operations to be performed during the process and can include one or more settings or parameters associated with each operation. For example, a laser material processing operation can include a material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, or focus position, etc.

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

Although embodiments of the disclosure are discussed in terms of determining predictive data 160 for determining outcomes of laser material processing operations based on processing parameter data 132 for laser material processing in manufacturing facilities (e.g., substrate processing facilities), in some embodiments, the disclosure can also be generally applied to laser material processing in any kind of manufacturing facility.

FIG. 2 illustrates a data set generator 272 (e.g., data set generator 172 of FIG. 1) to create data sets for a machine learning model (e.g., associated with obtaining predicted performance data associated with processing parameters for processing a material and causing, based on the predicted performance data, the material to be processed according to the processing parameters, methods 500A-C, etc.) (e.g., model 190 of FIG. 1), according to certain embodiments. In some embodiments, data set generator 272 is part of server machine 170 of FIG. 1. The data sets generated by data set generator 272 of FIG. 2 may be used to train a machine learning model (e.g., see FIG. 5B) to obtain predicted performance data associated with processing parameters for processing a material and cause, based on the predicted performance data, the material to be processed according to the processing parameters.

Data set generator 272 (e.g., data set generator 172 of FIG. 1) creates data sets for a machine learning model (e.g., model 190 of FIG. 1). Data set generator 272 creates data sets using historical processing parameters data 244 (e.g., historical processing parameters data 134 of FIG. 1) and historical performance data 254 (e.g., historical performance data 154 of FIG. 1). System 200 of FIG. 2 illustrates data set generator 272, data inputs 210, and target output 220 (e.g., target data).

In some embodiments, data set generator 272 generates a data set (e.g., training set, validating set, testing set) that includes one or more data inputs 210 (e.g., training input, validating input, testing input). In some embodiments, data set generator 272 does not generate target output (e.g., for unsupervised learning). In some embodiments, data set generator generates one or more target outputs 220 (e.g., for supervised learning) that correspond to the data inputs 210. The data set may also include mapping data that maps the data inputs 210 to the target outputs 220. Data inputs 210 are also referred to as “features,” “attributes,” or information.” In some embodiments, data set generator 272 provides the data set to the training engine 182, validation engine 184, or testing engine 186, where the data set is used to train, validate, or test the machine learning model 190 (e.g., associated with obtaining predicted performance data associated with processing parameters for processing a material and causing, based on the predicted performance data, the material to be processed according to the processing parameters, methods 500A-C, etc.).

In some embodiments, data set generator 272 generates the data input 210 and target output 220. In some embodiments, data inputs 210 include one or more sets of historical processing parameters data 244 (e.g., associated with obtaining predicted performance data associated with processing parameters for processing a material and causing, based on the predicted performance data, the material to be processed according to the processing parameters, methods 500A-C, etc.). In some embodiments, historical performance data 254 includes one or more of performance data from one or more types of sensors and/or metrology equipment, combination of performance data from one or more types of sensors and/or metrology equipment, patterns from performance data from one or more types of sensors and/or metrology equipment, and/or the like.

In some embodiments, data set generator 272 generates a first data input corresponding to a first set of historical processing parameters data 244A to train, validate, or test a first machine learning model and the data set generator 272 generates a second data input corresponding to a second set of historical processing parameters data 244B to train, validate, or test a second machine learning model (e.g., associated with obtaining predicted performance data associated with processing parameters for processing a material and causing, based on the predicted performance data, the material to be processed according to the processing parameters, methods 500A-C, etc.).

In some embodiments, the data set generator 272 discretizes (e.g., segments) one or more of the data input 210 or the target output 220 (e.g., to use in classification algorithms for regression problems). Discretization (e.g., segmentation via a sliding window) of the data input 210 or target output 220 transforms continuous values of variables into discrete values. In some embodiments, the discrete values for the data input 210 indicate discrete historical processing parameters data 134 to obtain a target output 220 (e.g., discrete historical performance data 154 associated with obtaining predicted performance data associated with processing parameters for processing a material and causing, based on the predicted performance data, the material to be processed according to the processing parameters, methods 500A-C, etc.).

Data inputs 210 and target outputs 220 to train, validate, or test a machine learning model may include information for a particular facility (e.g., for a particular substrate manufacturing facility). In some examples, historical processing parameters data 244 and historical performance data 254 are for the same manufacturing facility (e.g., associated with obtaining predicted performance data associated with processing parameters for processing a material and causing, based on the predicted performance data, the material to be processed according to the processing parameters, methods 500A-C, etc.).

In some embodiments, the information used to train the machine learning model is from specific types of manufacturing equipment 124 (e.g., laser material processing system 125) of the manufacturing facility having specific characteristics and allows the trained machine learning model (e.g., associated with obtaining predicted performance data associated with processing parameters for processing a material and causing, based on the predicted performance data, the material to be processed according to the processing parameters, methods 500A-C, etc.) to determine outcomes for a specific group of manufacturing equipment 124 based on input for current parameters (e.g., current processing parameters data 136) associated with one or more components sharing characteristics of the specific group. In some embodiments, the information used to train the machine learning model is for components from two or more manufacturing facilities and allows the trained machine learning model to determine outcomes for components based on input from one manufacturing facility.

In some embodiments, subsequent to generating a data set and training, validating, or testing a machine learning model 190 (e.g., associated with obtaining predicted performance data associated with processing parameters for processing a material and causing, based on the predicted performance data, the material to be processed according to the processing parameters, methods 500A-C, etc.) using the data set, the machine learning model 190 is further trained, validated, or tested (e.g., current performance data 156 of FIG. 1) or adjusted (e.g., adjusting weights associated with input data of the machine learning model 190, such as connection weights in a neural network).

The machine learning model processes the input to generate an output (e.g., associated with obtaining predicted performance data associated with processing parameters for processing a material and causing, based on the predicted performance data, the material to be processed according to the processing parameters, methods 500A-C, etc.). An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine learning model can produce.

Accordingly, the output can include one or more predictions or inferences (e.g., associated with obtaining predicted performance data associated with processing parameters for processing a material and causing, based on the predicted performance data, the material to be processed according to the processing parameters, methods 500A-C, etc.). For example, an output prediction or inference can include one or more predictions of uniformity and quality of laser drilling, uniformity and quality of laser etching, uniformity and quality of laser annealing, uniformity and quality of laser ablation, uniformity and quality of laser doping, uniformity and quality of laser scribing, uniformity and quality of laser welding, uniformity and quality of laser deposition, uniformity and quality of laser trim and repair, and so on.

For example, predictive data (e.g., predictive data 160, predicted performance data 162, etc.) for a laser drilling operation may be indicative of hole diameter, hole depth, hole quality (e.g., drilled holes should meet expected dimensions accurately and consistently and have little thermal damage or recast layers), etc. Predictive data for a laser etching operation may be indicative of feature accuracy (etched features should have precise dimensions, shapes, and edge quality), etch depth control (etching process should achieve the desired depth accurately and uniformly across the substrate), surface finish (etched surface should be smooth, free from roughness, and have the desired texture or pattern), etc. Predictive data for a laser annealing operation may be indicative of dopant activation (annealing process should effectively activate the dopants, achieving the desired electrical properties in the treated regions), crystal structure restoration (annealing process should eliminate amorphous regions or crystal defects), etc. Predictive data for a laser ablation operation may be indicative of material removal accuracy (laser ablation process should remove material precisely), surface quality (ablated surface should exhibit minimal heat-affected zones or recast layers), etc. Performance data for a laser doping operation may be indicative of dopant incorporation (laser doping process should successfully introduce dopant atoms into the desired regions and achieved desired doping concentration), etc. Predictive data for a laser scribing operation may be indicative of line accuracy (laser scribing process should create precise and well-defined scribe lines with the desired width, depth, and edge quality), scribe width control (scribing process should accurately control the width of the scribe lines to avoid any electrical or structural issues), etc. Predictive data for a laser welding operation may be indicative of bond strength (laser welding should result in strong and reliable bonds between the joined components, meeting the specified mechanical and electrical requirements), heat-affected zone control (laser welding process should minimize the size and impact of the heat-affected zone to prevent damage to the surrounding materials or components), etc. Predictive data for a laser deposition operation may be indicative of layer thickness control (laser deposition should achieve the desired thickness and uniformity of deposited layers), adhesion, integrity (deposited layers should adhere well to the substrate and exhibit good integrity without cracks, delamination, or voids), etc. Predictive data for a laser trim and repair operation may be indicative of component modification accuracy (laser trim and repair processes should accurately modify circuitry or structures as required, achieving the desired modifications without causing unintended damage or changes), etc.

In some embodiments, processing logic determines an error (e.g., a classification error) based on the differences between the output (e.g., predictions or inferences) of the machine learning model and target labels associated with the input training data. Processing logic adjusts weights of one or more nodes in the machine learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer.

Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy can be, for example, 70%, 80% or 90% accuracy. In one embodiment, the stopping criterion is met if accuracy of the machine learning model has stopped improving. If the stopping criterion has not been met, further training is performed. If the stopping criterion has been met, training can be complete. Once the machine learning model is trained, a reserved portion of the training dataset can be used to test the model.

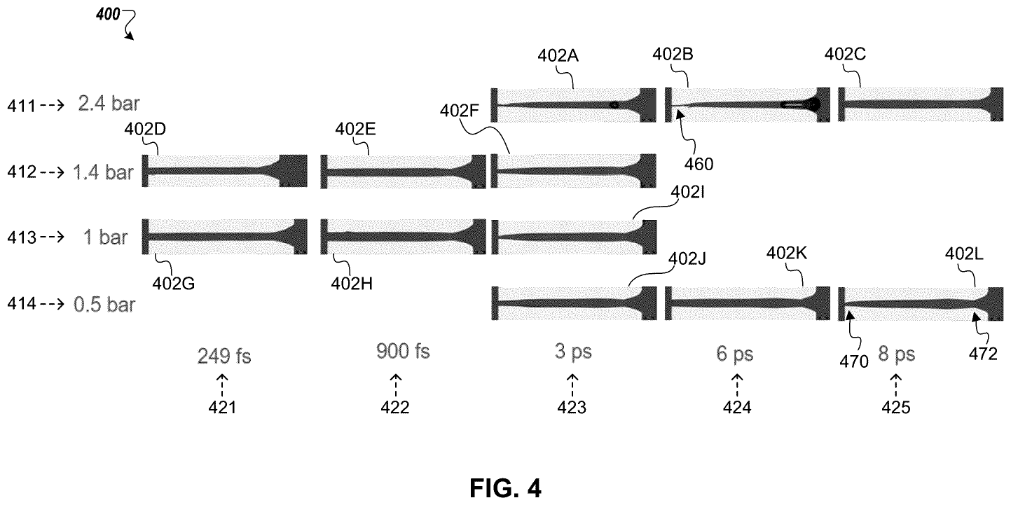

FIG. 3 is a block diagram illustrating a system 300 for generating predictive data 360 (e.g., predictive data 160 of FIG. 1), according to certain embodiments. The system 300 is used to determine predictive data 360 via a trained machine learning model (e.g., model 190 of FIG. 1) associate with obtaining predicted performance data associated with processing parameters for processing a material and causing, based on the predicted performance data, the material to be processed according to the processing parameters (e.g., executing a laser material processing operation when predicted performance data indicates use of certain processing parameters is acceptable).

At block 310, the system 300 (e.g., predictive system 110 of FIG. 1) performs data partitioning (e.g., via data set generator 172 of server machine 170 of FIG. 1) of the historical data (e.g., historical processing parameters data 344 and/or historical performance data 354 for model 190 of FIG. 1) to generate the training set 302, validation set 304, and testing set 306 (e.g., associated with obtaining predicted performance data associated with processing parameters for processing a material and causing, based on the predicted performance data, the material to be processed according to the processing parameters, methods 500A-C, etc.). In some examples, the training set is 60% of the historical data, the validation set is 20% of the historical data, and the testing set is 20% of the historical data. The system 300 generates a plurality of sets of features for each of the training set, the validation set, and the testing set. In some examples, if the historical data includes features derived from 20 sensors (e.g., sensors 126 of FIG. 1, sensors of manufacturing equipment and/or metrology equipment) and 100 products (e.g., products that each correspond to property data from the 20 sensors), a first set of features is sensors 1-10, a second set of features is sensors 11-20, the training set is products 1-60, the validation set is products 61-80, and the testing set is products 81-100. In this example, the first set of features of the training set would be parameters from sensors 1-10 for products 1-60.

At block 312, the system 300 performs model training (e.g., via training engine 182 of FIG. 1 associated with obtaining predicted performance data associated with processing parameters for processing a material and causing, based on the predicted performance data, the material to be processed according to the processing parameters, methods 500A-C, etc.) using the training set 302. In some embodiments, the system 300 trains multiple models using multiple sets of features of the training set 302 (e.g., a first set of features of the training set 302, a second set of features of the training set 302, etc.). For example, system 300 trains a machine learning model to generate a first trained machine learning model using the first set of features in the training set (e.g., performance data from sensors 1-10 for products 1-60) and to generate a second trained machine learning model using the second set of features in the training set (e.g., performance data from sensors 11-20 for products 1-60). In some embodiments, the first trained machine learning model and the second trained machine learning model are combined to generate a third trained machine learning model (e.g., which is a better predictor than the first or the second trained machine learning model on its own in some embodiments). In some embodiments, sets of features are used in comparing models overlap (e.g., first set of features being performance data from sensors 1-15 and second set of features being performance data from sensors 5-20). In some embodiments, hundreds of models are generated including models with various permutations of features and combinations of models.

At block 314, the system 300 performs model validation (e.g., via validation engine 184 of FIG. 1) using the validation set 304. The system 300 validates each of the trained models (e.g., associated with obtaining predicted performance data associated with processing parameters for processing a material and causing, based on the predicted performance data, the material to be processed according to the processing parameters, methods 500A-C, etc.) using a corresponding set of features of the validation set 304. For example, system 300 validates the first trained machine learning model using the first set of features in the validation set (e.g., parameters from sensors 1-10 for products 61-80) and the second trained machine learning model using the second set of features in the validation set (e.g., parameters from sensors 11-20 for products 61-80). In some embodiments, the system 300 validates hundreds of models (e.g., models with various permutations of features, combinations of models, etc.) generated at block 312. At block 314, the system 300 determines an accuracy of each of the one or more trained models (e.g., via model validation) and determines whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. The system 300 discards the trained machine learning models that have an accuracy that is below the threshold accuracy (e.g., based on the validation set).

At block 316, the system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow returns to block 312 where the system 300 performs model training using further refined training sets corresponding to further refined sets of features for determining a trained model that has the highest accuracy.

At block 318, the system 300 performs model testing (e.g., via testing engine 186 of FIG. 1) using the testing set 306 to test the selected model 308. The system 300 tests, using the first set of features in the testing set (e.g., performance data from sensors 1-10 for products 81-100), the first trained machine learning model to determine the first trained machine learning model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where the system 300 performs model training (e.g., retraining) using different training sets corresponding to different sets of features (e.g., performance data from different sensors). Responsive to determining that the selected model 308 has an accuracy that meets a threshold accuracy based on the testing set 306, flow continues to block 320. In at least block 312, the model learns patterns in the historical data to make predictions and in block 318, the system 300 applies the model on the remaining data (e.g., testing set 306) to test the predictions (e.g., associated with obtaining predicted performance data associated with processing parameters for processing a material and causing, based on the predicted performance data, the material to be processed according to the processing parameters, methods 500A-C, etc.).

At block 320, system 300 uses the trained model (e.g., selected model 308) to receive current processing parameters data 346 (e.g., current processing parameters data 136 of FIG. 1) and determines (e.g., extracts), from the trained model, predictive data 360 (e.g., predictive data 160 of FIG. 1) associated with obtaining predicted performance data associated with processing parameters for processing a material and causing, based on the predicted performance data, the material to be processed according to the processing parameters (e.g., causing execution of processing based on predicted performance data indicating that certain processing parameters are acceptable). In some embodiments, the current processing parameters data 346 corresponds to the same types of features in the historical processing parameters data 344. In some embodiments, the current processing parameters data 346 corresponds to a same type of features as a subset of the types of features in historical processing parameters data 344 that is used to train the selected model 308 (e.g., associated with obtaining predicted performance data associated with processing parameters for processing a material and causing, based on the predicted performance data, the material to be processed according to the processing parameters, methods 500A-C, etc.).

In some embodiments, current data is received. In some embodiments, current data includes current performance data 356 (e.g., current performance data 156 of FIG. 1) and/or current processing parameters data 346 (e.g., associated with obtaining predicted performance data associated with processing parameters for processing a material and causing, based on the predicted performance data, the material to be processed according to the processing parameters, methods 500A-C, etc.). In some embodiments, at least a portion of the current data is received from metrology equipment (e.g., metrology equipment 128 of FIG. 1) or via user input. In some embodiments, the model is re-trained based on the current data. In some embodiments, a new model is trained based on the current performance data 356 and the current processing parameters data 346.

In some embodiments, one or more of the blocks 310-320 occur in various orders and/or with other operations not presented and described herein. In some embodiments, one or more of blocks 310-320 are not to be performed. For example, in some embodiments, one or more of data partitioning of block 310, model validation of block 314, model selection of block 316, and/or model testing of block 318 are not to be performed.

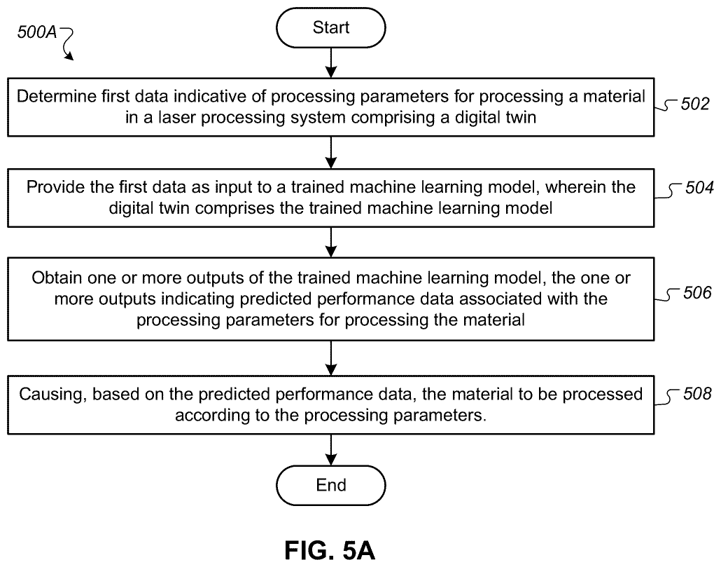

FIG. 4 is an example of predicted profiles of a material processed by a laser material processing system, according to some embodiments.

In some embodiments, predicted profiles 402A-L may be predictions of cross-sectional images of processed materials (e.g., substrates during and/or after a laser material processing operation). In some embodiments, predicted profiles 402A-L may be predicted optical micrographs. In some embodiments, predicted profiles may be generated extrapolations of a training set. In some embodiments, a training set may include similar images to the predictions (e.g., cross sectional images of processed materials). In some embodiments, a validation set may include similar images to the predictions and/or the training set (e.g., cross sectional images of processed materials).

In some embodiments, predicted profiles 402A-L may be a map of a process space 400. For example, in some embodiments predicted profiles 420A-L may be arranged in rows and columns. Rows 411-414 correspond to a first processing parameter (e.g., pressure) and columns 421-425 a second processing parameter (e.g., pulse time). In some embodiments, the intersection of a row and column represents a predicted profile of a substrate and/or material processed using the processing parameters defined by the respective row and column. For example, predicted profile 402G represents a predicted profile of a substrate drilled by a laser material processing system under 1 bar of pressure and with a laser pulse time of 249 femtoseconds.

In some embodiments, processing parameters used to generate predicted profile 402G (e.g., 1 bar of pressure and laser pulse time of 249 femtoseconds) may be determined to be preferred processing parameters because of the uniformity and quality of the hole drilled. In some embodiments, for example, the processing parameters used to generate predicted profile 402B (e.g., 2.4 bars of pressure and laser pulse time of 6 picoseconds) may not be preferred processing parameters because of the lack of uniformity and quality of the hole drilled. For example, region 460 of predicted profile 402B exhibits tapering. In some embodiments, tapering is an undesirable quality of a hole resulting from a laser drilling operation. Further, the processing parameters used to generate predicted profile 402L (e.g., 0.5 bars of pressure and laser pulse time of 8 picoseconds) may not be preferred processing parameters because of the lack of uniformity and quality of the hole drilled. For example, region 470 of predicted profile 402L exhibits tapering. In some embodiments, tapering is an undesirable quality of a hole resulting from a laser drilling operation. Further, region 472 of predicted profile 402L exhibits necking. In some embodiments, necking is an undesirable quality of a hole resulting from a laser drilling operation.

FIGS. 5A-B are flow diagrams of methods 500A-B associated with obtaining predicted performance data associated with processing parameters for processing a material and causing, based on the predicted performance data, the material to be processed according to the processing parameters, according to certain embodiments. In some embodiments, methods 500A-B are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In one implementation, method 500A can be performed by a computer system, such as the one shown in FIG. 1. In other or similar implementations, one or more operations of method 500A can be performed by one or more other machines not depicted in the figures. In some embodiments, methods 500A-B are performed, at least in part, by predictive system 110. In some embodiments, method 500A is performed by client device 120 (e.g., processing execution component 122) and/or predictive system 110 (e.g., predictive component). In some embodiments, method 500B is performed by server machine 180 (e.g., training engine 182, etc.). In some embodiments, a non-transitory storage medium stores instructions that when executed by a processing device (e.g., of predictive system 110, of server machine 180, of predictive server 112, of client device 120, etc.), cause the processing device to perform one or more of methods 500A-B.

For simplicity of explanation, methods 500A-B are depicted and described as a series of operations. However, operations in accordance with this disclosure can occur in various orders and/or concurrently and with other operations not presented and described herein. Furthermore, in some embodiments, not all illustrated operations are performed to implement methods 500A-B in accordance with the disclosed subject matter. In addition, those skilled in the art will understand and appreciate that methods 500A-B could alternatively be represented as a series of interrelated states via a state diagram or events.

FIG. 5A is a flow diagram of a method associated with obtaining predicted performance data associated with processing parameters for processing a material and causing, based on the predicted performance data, the material to be processed according to the processing parameters, according to aspects of the present disclosure. In some embodiments, FIG. 5A includes using a trained machine learning model (e.g., model 190 of FIG. 1) to provide one or more outputs, the one or more outputs indicating predicted performance data associated with processing parameters for processing a material and to cause, based on the predicted performance data, the material to be processed according to the processing parameters.

Referring to FIG. 5A, in some embodiments, at block 502 the processing logic implementing the method 400A determines first data indicative of processing parameters for processing a material in a laser processing system. In some embodiments, the laser material processing system includes a digital twin.

In some embodiments, the processing parameters comprise at least one of material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, focus position, and/or the like. In some embodiments, the processing parameters for processing the material in the laser processing system are determined based on user input.

At block 504, the processing logic provides the first data as input to a trained machine learning model. In some embodiments, the digital twin includes the trained machine learning model.

At block 506, the processing logic obtains one or more outputs of the trained machine learning model, the one or more outputs indicating predicted performance data associated with the processing parameters for processing the material.

In some embodiments, the predicted performance data includes a predicted profile of the processed material.

In some embodiments, the processing logic may further determine preferred processing parameters, where the preferred processing parameters are determined based on the predicted performance data meeting a performance criterion. In some embodiments, the performance criterion is a uniformity criterion.

At block 508, the processing logic causes, based on the predicted performance data, the material to be processed according to the processing parameters.

In some embodiments, the processing logic may further train a machine learning model using training input data including historical processing parameters data (e.g., of historical processing operations) and training target output data including historical performance data (e.g., substrate quality using historical processing parameters, material uniformity after being processed using certain processing parameters, etc.) associated with the historical processing parameters.

In some embodiments, the processing logic may further determine second data indicative of updated processing parameters for processing the material in the laser processing system, where the second data is based on performance data of the material processed according to the processing parameters. In some embodiments, the processing logic may further provide the second data as input to the trained machine learning model. In some embodiments, the processing logic may further obtain one or more second outputs of the trained machine learning model, the one or more second outputs indicating updated predicted performance data associated with updated processing parameters for processing the material. In some embodiments, the processing logic may further cause, based on the updated predicted performance data, the material to be processed according to the updated processing parameters.

In some embodiments, method 500A may include training a machine learning model (e.g., using data input including historical processing parameters data and/or target output including historical performance data to generate a trained machine learning model) to provide one or more outputs, the one or more outputs indicating predicted performance data associated with processing parameters for processing a material and to cause, based on the predicted performance data, the material to be processed according to the processing parameters. In some embodiments, method 500A includes using the trained machine learning model (e.g., using data input including processing parameters data and/or target output including predicted performance data) to predict the outcome of a processing operation (e.g., laser material processing operation) based on processing parameters (e.g., processing parameter values, processing setting, etc.).

The predictive data may be associated with predicted performance data (e.g., performance data of the substrate or performance data of a material after undergoing a processing operation, e.g., laser material processing operation) based on predictive data. Responsive to the predicted performance data meeting a threshold (e.g., processed material/substrate meets a performance criterion after being processed using certain parameters), the processing logic may cause execution of a processing operation according to the processing parameters (e.g., laser material processing operation using 1 bar of pressure and laser pulse time of 249 femtoseconds). In some embodiments, responsive to the predicted performance data not meeting a threshold (e.g., processed material/substrate does not meet a performance criterion after being processed using certain parameters), the processing logic may cause the processing operation to not be executed according to the processing parameters (e.g., laser material processing operation using 0.5 bar of pressure and laser pulse time of 8 picoseconds) and may cause a prediction to be made based on updated processing parameters (e.g., updating parameter values, updating process recipe, etc.). Responsive to the predicted performance data meeting the threshold value, the process logic may cause execution of a processing operation according to the updated processing parameters (e.g., laser material processing operation using 1 bar of pressure and laser pulse time of 249 femtoseconds).

FIG. 5B is a flow diagram of a method for training a machine learning model (e.g., model 190 of FIG. 1) for determining predictive data (e.g., predictive data 160 of FIG. 1) associated with obtaining predicted performance data associated with processing parameters for processing a material and causing, based on the predicted performance data, the material to be processed according to the processing parameters, according to aspects of the present disclosure.

Referring to FIG. 5B, at block 510 of method 500B, the processing logic identifies historical processing parameters data (e.g., historical processing parameters data 134 of FIG. 1). Historical processing parameters data may include data from historical laser material processing operations, historical laser material processing recipes, and/or the like.

In some embodiments, at block 512, the processing logic identifies historical performance data (e.g., historical performance data 154 of FIG. 1) of the substrates, processed materials, and/or the like. Historical performance data may include data from historical substrates and/or materials processed in a laser material processing system (e.g., laser material processing system 125 of FIG. 1) according to processing parameters. Performance data, including historical performance data, may include metrology data or user input that indicates the performance of a substrate in conforming to certain parameters or achieving certain levels of performance (e.g., uniformity measures, quality measures, ability to pass probe tests measuring voltage, etc.). Performance data, including historical performance data, may include metrology data or user input that indicates the performance of a processed material in meeting certain parameters or achieving certain levels of performance (e.g., meeting a uniformity threshold, meeting a conductivity threshold, etc.). At least a portion of the historical processing parameters data and the historical performance data may be associated with new substrate processing equipment parts (e.g., used for benchmarking). At least a portion of the historical processing parameters data and the historical performance data may be associated with manufactured substrates and/or processed materials. At least a portion of the historical processing parameters data and the historical performance data may be associated with laser processed materials.

At block 514, the processing logic trains a machine learning model using data input including historical processing parameters data 134 and/or target output including the historical performance data 154 to generate a trained machine learning model.

In some embodiments, the historical processing parameters data is historical processing parameters used to process historical substrates and/or the historical performance data corresponds to the historical processing parameters used to process the historical substrates. In some embodiments, the historical processing parameters data includes historical processing parameters used to process historical substrates and/or the historical performance data corresponds to the historical substrates (e.g., processed using the historical processing parameters). In some embodiments, the historical performance data includes historical metrology of historical substrates (e.g., processed using historical processing parameters). The historical performance data may be associated with substrate quality, such as metrology data of substrates, substrate uniformity, operation outcome quality, substrate defects, etc. The historical performance data may be associated with quality of a material and/or substrate processed by a laser material processing system, metrology data of the substrates/materials, etc.

At block 514, the machine learning model may be trained using historical processing parameters data and/or target output including the historical performance data to generate a trained machine learning model configured to predict the outcome of laser material processing operations by a laser material processing system and cause a material to be processed according to the processing parameters data (e.g., processing parameter data of block 502 of FIG. 5A). In some embodiments, the machine learning model may be trained using historical processing parameters data and/or target output including the historical performance data to generate a trained machine learning model configured to provide one or more outputs, the one or more outputs indicating predicted performance data associated with processing parameters for processing the material and cause, based on the predicted performance data, the material to be processed according to the processing parameters.

In some embodiments, the trained machine learning model may be configured to predict performance data 152 (e.g., performance data of substrates/materials processed using processing parameters, preferred processing parameters, etc.) based on processing parameters data 132 (e.g., processing parameters data of blocks 502 and 504 of FIG. 5A). Responsive to the predicted performance data meeting a threshold (e.g., processed material/substrate meets a performance criterion after being processed using certain parameters), the processing logic may cause execution of a processing operation according to the processing parameters (e.g., e.g., laser material processing operation using 1 bar of pressure and laser pulse time of 249 femtoseconds).

In some embodiments, responsive to the predicted performance data not meeting a threshold (e.g., processed material/substrate does not meet a performance criterion after being processed using certain parameters), the processing logic may cause the processing operation to not be executed according to the processing parameters (e.g., laser material processing operation using 0.5 bar of pressure and laser pulse time of 8 picoseconds) and may cause a prediction to be made based on updated processing parameters to be (e.g., updating parameter values, updating process recipe, etc.). Responsive to the predicted performance data meeting the threshold value, the process logic may cause execution of a processing operation according to the updated processing parameters (e.g., laser material processing operation using 1 bar of pressure and laser pulse time of 249 femtoseconds).

In some embodiments, the historical processing parameters data of block 510 is of historical substrates and/or historical materials and the historical performance data of block 512 corresponds to the historical substrates and/or historical materials. In some embodiments, the historical processing parameters data of block 510 is associated with historical processing parameters used during the processing of historical substrates/materials and the historical performance data of block 512 corresponds to the historical substrates/materials (e.g., processed using the historical processing parameters).

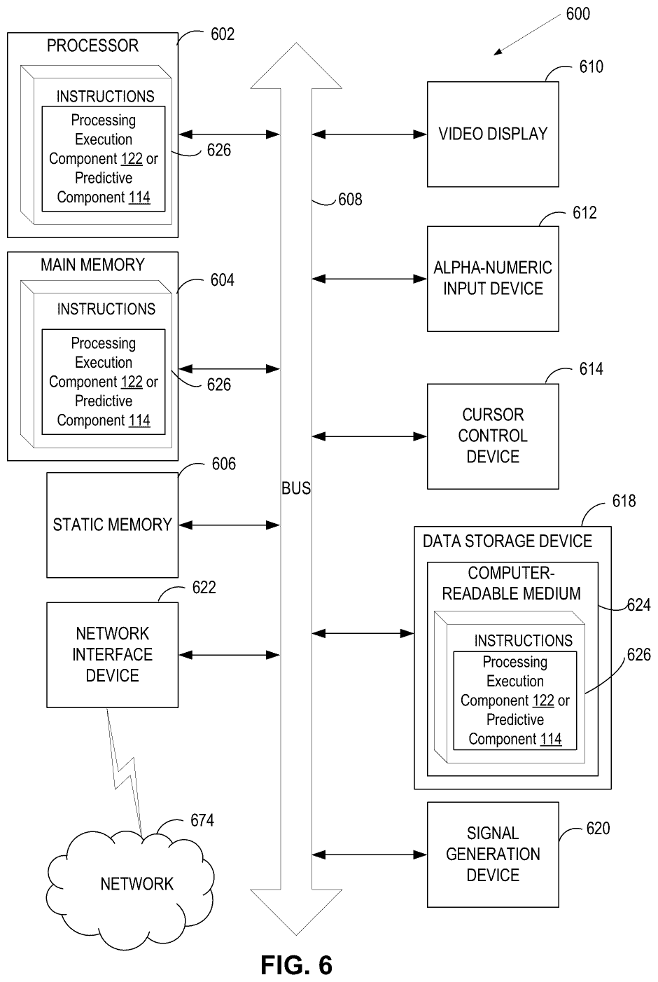

FIG. 6 is a block diagram illustrating a computer system 600, according to certain embodiments. In some embodiments, the computer system 600 is one or more of client device 120, predictive system 110, server machine 170, server machine 180, predictive server 112, and/or the like.

In some embodiments, computer system 600 is connected (e.g., via a network, such as a Local Area Network (LAN), an intranet, an extranet, or the Internet) to other computer systems. In some embodiments, computer system 600 operates in the capacity of a server or a client computer in a client-server environment, or as a peer computer in a peer-to-peer or distributed network environment. In some embodiments, computer system 600 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 includes a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which communicate with each other via a bus 608.

In some embodiments, processing device 602 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 600 further includes a network interface device 622 (e.g., coupled to network 674). In some embodiments, computer system 600 also includes a video display unit 610 (e.g., a liquid crystal display (LCD)), an alphanumeric input device 612 (e.g., a keyboard), a cursor control device 614 (e.g., a mouse), and a signal generation device 620.

In some implementations, data storage device 618 includes a non-transitory computer-readable storage medium 624 on which store instructions 626 encoding any one or more of the methods or functions described herein, including instructions encoding components of FIG. 1 (e.g., processing execution component 122, predictive component 114, etc.) and for implementing methods described herein (e.g., one or more of methods 500A-C).

In some embodiments, instructions 626 also reside, completely or partially, within volatile memory 604 and/or within processing device 602 during execution thereof by computer system 600, hence, in some embodiments, volatile memory 604 and processing device 602 also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as application specific integrated circuits (ASICS), FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “determining,” “providing,” “obtaining,” “causing,” “training,” “receiving,” “identifying,” “performing,” “causing,” “accessing,” “adding,” “using,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method, comprising:
determining first data indicative of processing parameters for processing a material in a laser processing system comprising a digital twin;
providing the first data as input to a trained machine learning model, wherein the digital twin comprises the trained machine learning model;
obtaining one or more outputs of the trained machine learning model, the one or more outputs indicating predicted performance data associated with the processing parameters for processing the material; and
causing, based on the predicted performance data, the material to be processed according to the processing parameters.

2. The method of claim 1, wherein the processing parameters comprise at least one of material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, or focus position.

3. The method of claim 1, wherein the predicted performance data comprises a predicted profile of the processed material.

4. The method of claim 1, further comprising:
determining preferred processing parameters, wherein the preferred processing parameters are determined based on the predicted performance data meeting a performance criterion.

5. The method of claim 4, wherein the performance criterion is a uniformity criterion.

6. The method of claim 1, wherein the processing parameters for processing the material in the laser processing system are determined based on user input.

7. The method of claim 1, further comprising:
training the machine learning model using training input data comprising historical processing parameters data and training target output data comprising historical performance data associated with the historical processing parameters.

8. The method of claim 1, further comprising:
determining second data indicative of updated processing parameters for processing the material in the laser processing system, wherein the second data is based on performance data of the material processed according to the processing parameters;
providing the second data as input to the trained machine learning model;
obtaining one or more second outputs of the trained machine learning model, the one or more second outputs indicating updated predicted performance data associated with updated processing parameters for processing the material; and
causing, based on the updated predicted performance data, the material to be processed according to the updated processing parameters.

9. A system comprising:
a memory; and
a processing device coupled to the memory, the processing device to:
determine first data indicative of processing parameters for processing a material in a laser processing system comprising a digital twin;
provide the first data as input to a trained machine learning model, wherein the digital twin comprises the trained machine learning model;
obtain one or more outputs of the trained machine learning model, the one or more outputs indicating predicted performance data associated with the processing parameters for processing the material; and
cause, based on the predicted performance data, the material to be processed according to the processing parameters.

10. The system of claim 9, wherein the processing parameters comprise at least one of material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, or focus position.

11. The system of claim 9, the processing device further to:
determine preferred processing parameters, wherein the preferred processing parameters are determined based on the predicted performance data meeting a performance criterion.

12. The system of claim 11, wherein the performance criterion is a uniformity criterion.

13. The system of claim 9, the processing device further to:
train the machine learning model using training input data comprising historical processing parameters data and training target output data comprising historical performance data associated with the historical processing parameters.

14. The system of claim 9, the processing device further to:
determine second data indicative of updated processing parameters for processing the material in the laser processing system, wherein the second data is based on performance data of the material processed according to the processing parameters;
provide the second data as input to the trained machine learning model;
obtain one or more second outputs of the trained machine learning model, the one or more second outputs indicating updated predicted performance data associated with updated processing parameters for processing the material; and
cause, based on the updated predicted performance data, the material to be processed according to the updated processing parameters.

15. A non-transitory machine-readable storage medium comprising instructions that, when executed by a processing device, cause the processing device to:
determine first data indicative of processing parameters for processing a material in a laser processing system comprising a digital twin;
provide the first data as input to a trained machine learning model, wherein the digital twin comprises the trained machine learning model;
obtain one or more outputs of the trained machine learning model, the one or more outputs indicating predicted performance data associated with the processing parameters for processing the material; and
cause, based on the predicted performance data, the material to be processed according to the processing parameters.

16. The non-transitory machine-readable storage medium of claim 15, wherein the processing parameters comprise at least one of material type, material strength, material thermal conductivity, material reflectance, laser type, laser wavelength, pulse energy, pulse duration, repetition rate, hatch distance, beam diameter, beam shape, beam alignment, beam incidence, gas pressure, focal length, polarization, marking speed, milling strategy, scanning speed, scan pattern, beam collimation, or focus position.

17. The non-transitory machine-readable storage medium of claim 15, the processing device further to:
determine preferred processing parameters, wherein the preferred processing parameters are determined based on the predicted performance data meeting a performance criterion.

18. The non-transitory machine-readable storage medium of claim 17, wherein the performance criterion is a uniformity criterion.

19. The non-transitory machine-readable storage medium of claim 15, the processing device further to:
train the machine learning model using training input data comprising historical processing parameters data and training target output data comprising historical performance data associated with the historical processing parameters.

20. The non-transitory machine-readable storage medium of claim 15, the processing device further to:
determine second data indicative of updated processing parameters for processing the material in the laser processing system, wherein the second data is based on performance data of the material processed according to the processing parameters;
provide the second data as input to the trained machine learning model;
obtain one or more second outputs of the trained machine learning model, the one or more second outputs indicating updated predicted performance data associated with updated processing parameters for processing the material; and
cause, based on the updated predicted performance data, the material to be processed according to the updated processing parameters.
